(19) United States
(12) Patent Application Publication
(10) Pub. No.: US 2004/0240791 A1
(43) Pub. Date: Dec. 2, 2004

(54) OPTICAL DISK REPRODUCING DEVICE

(76) Inventor: Tsung-Jung Kuo, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,919

(22) Filed: Nov. 6, 2003

(30) Foreign Application Priority Data
May 30, 2003 (TW) 092114771

(51) Int. Cl. G02B 6/36

(52) U.S. Cl. 385/53

(57) ABSTRACT

An optical disk reproducing device includes an external optical disk drive and a detachable module. The external optical disk drive can reproduce data from the optical disk, and the detachable module is equipped with audio output or video output. The external optical disk drive is equipped with a connector and the detachable module is equipped with a corresponding connector. The detachable module is connected with an audio or video output device via the audio or video output connector respectively. After data is processed in the external disk drive, it is easily sent to the audio or video output device. All a user has to do is attach the external optical disk drive to the detachable module, and then the optical disk reproducing device begins to reproduce or play data from the optical disk. Thus, it is very convenient for the user to enjoy the music or video playback.

### BACKGROUND OF INVENTION

1. Field of the Invention

The present invention relates to an optical disk reproducing device, and in particular to an optical disk reproducing drive having a detachable module for audio/video output or data processing.

2. Description of the Prior Art

Since the advent of optical storage devices, external optical disk drives are becoming more popular in the market; such external optical disk drives having been considered as standard equipment on personal computers for several years. A user can move an external optical disk drive from one system to another easily, since it is convenient for the user to plug the external optical disk drive into a system or unplug the external optical disk drive from the system.

FIG. 1 illustrates the relationship between the external optical disk drive and the host computer in the prior art. An external optical disk drive 1 connects with a host computer 2 by a universal serial bus (USB) port, and the host computer 2 includes an audio adapter 3 and a video adapter 4. When the external optical disk drive 1 is in use (i.e. during audio playback or video playback), the host computer 2 receives audio or video data from the external optical disk drive 1. After processing, the audio data and the video data are sent to the audio adapter 3 and the video adapter 4 respectively. Finally, the audio data is sent from the audio adapter 3 to the audio output device 5 (e.g. stereo speaker) through a connector. Likewise, the video data is sent from the video adapter 4 to the video output device 6 (e.g. monitor) through a 15-pin or 20-pin connector. However, it is inconvenient for the user to listen to music or watch a video disk when the user just has the external optical disk drive 1. Even worse, one end of the connecting cable is connected with the external optical disk drive 1 by a dedicated connector, and the other end of the connecting cable is connected with the host computer 2 through the USB port.

Thus, in the prior art, such external optical disk drives require expensive dedicated connectors and must be connected with a host computer when the user wants to listen to music or watch a video program. Accordingly, there is need to develop an optical disk reproducing device having a detachable module for audio/video output or data processing.

### SUMMARY OF INVENTION

It is an object of the present invention to provide an optical disk reproducing device.

It is another object of the present invention to provide an optical disk reproducing drive having a detachable module for audio/video output or data processing.

In order to accomplish one object of the present invention, the present invention provides an optical disk reproducing drive having a detachable module. The optical disk reproducing device includes an external optical disk drive and a detachable module. The external optical disk drive can reproduce an optical disk, and the detachable module is equipped with an audio output connector or a video output connector. In addition, the external optical disk drive is equipped with an IDE connector and the detachable module is equipped with a corresponding IDE connector. The detachable module is connected with an audio output device or a video output device via the audio output connector or the video output connector respectively. After data is processed in the external optical disk drive, the data is easily sent to the audio output device or the video output device.

In order to accomplish one object of the present invention, the present invention provides an external optical disk reproducing drive having a detachable module. The external disk reproducing device includes an external optical disk drive and a detachable module. The external optical disk drive can reproduce an optical disk, and the detachable module is equipped with an audio output connector or a video output connector. In addition, the external optical disk drive is equipped with an USB connector and the detachable module is equipped with a corresponding USB connector. The detachable module is connected with an audio output device or a video output device via the audio output connector or the video output connector respectively. After data is processed in the external optical disk drive, the data is easily sent to the audio output device or the video output device.

In order to accomplish another object of the present invention, the present invention provides an external optical disk reproducing drive having a detachable module. The external disk reproducing device includes an external optical disk drive and a detachable module. The external optical disk drive can reproduce an optical disk, and the detachable module is equipped with an audio output connector or a video output connector. In addition, the external optical disk drive is equipped with a pin-to-pin connector and the detachable module is equipped with a corresponding pin-to-pin connector. The detachable module is connected with an audio output device or a video output device via the audio output connector or the video output connector respectively. After data is processed in the external optical disk drive, the data is easily sent to the audio output device or the video output device.

### BRIEF DESCRIPTION OF DRAWINGS

The present invention can be fully understood from the following detailed description and preferred embodiment with reference to the accompanying drawings in which:

FIG. 1 is a schematic diagram illustrating the implementation of an external optical disk drive and a host computer according to the prior art; and

FIG. 2 is a block diagram illustrating an optical disk reproducing device according to the embodiments of the present invention.

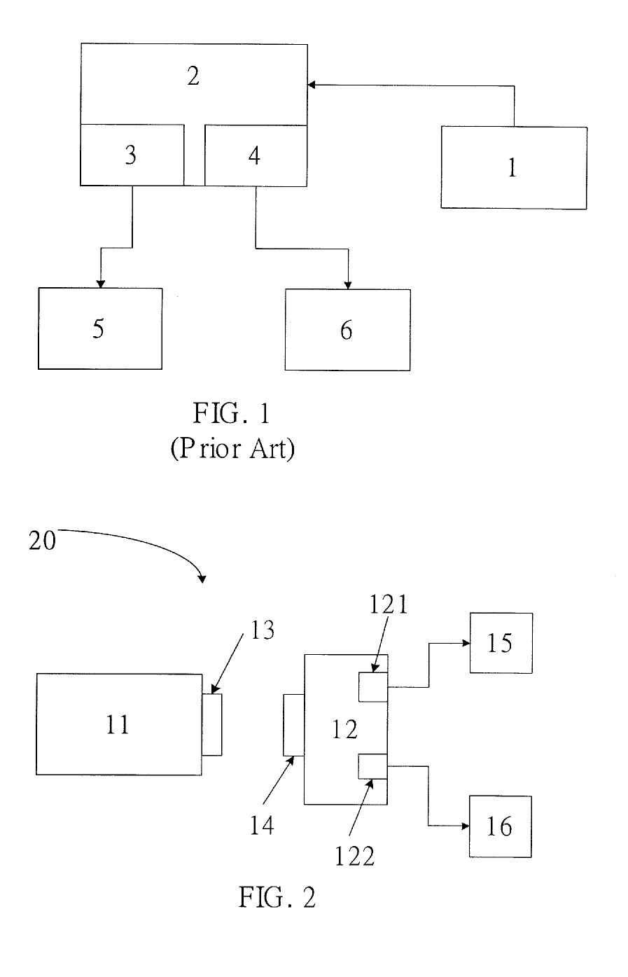

### DETAILED DESCRIPTION

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

Although the embodiments of the present invention are described below in connection with an external optical disk drive, the present invention can be applied to all optical disk drive, including but not limited to CD-ROM drives, DVD-ROM drives, CD-RW drives, DVD-RAM drives, DVD-RW drives, DVD+RW drives, COMBO drives, car audio players, external drives, as well as all other optical media recorders and players.

FIG. 2 illustrates an optical disk reproducing device 20 according to the present invention, and best illustrates the interconnections of the components of the optical disk reproducing device 20.

Referring to FIG. 2, the optical disk reproducing device 20 in accordance with the present invention includes an external optical disk drive 11 and a detachable module 12.

According to one embodiment of the present invention, the external optical disk drive 11 has a connector 13, and the detachable module 12 has a corresponding connector 14. For example, when the connector 13 of the external optical disk drive 11 is a USB connector (plug), the corresponding connector 14 is a USB socket able to receive the USB connector. The external optical disk drive 11 can be the same as the conventional external optical disk drive 1 and is capable of reproducing optical disks or performing music/movie playback. The detachable module 12 can include, but is not limited to having an audio output connector, a video output connector, a microphone-in connector, or other multimedia connectors. In this embodiment, the detachable module 12 can include an audio output connector 121 and a video output connector 122. In addition, the detachable module 12 can be connected with an audio output device 15 or a video output device 16 via the audio output connector 121 or the video output connector 122, respectively.

Furthermore, when the user would like to attach the external optical disk drive 11 to the detachable module 12, the user connects the connector 13 (USB connector) of the external optical disk drive 11 to the corresponding connector 14 (USB socket) of the detachable module 12. The user can place an optical disk (not shown) into the external optical disk drive 11. When the detachable module 12 is attached to the audio output device 15 or the video output device 16, the user can easily enjoy music or movie playback with the optical disk reproducing device 20. Thus, all the user has to do is simply attach the external optical disk drive 11 to the detachable module 12 for the data to be sent to the audio output device 15 or video output device 16. Connection of the external optical disk drive 11 to the host computer 2 is not required.

According to another embodiment of the present invention, the optical disk reproducing device 20 in accordance with the present invention includes the external optical disk drive 11 and the detachable module 12. The external optical disk drive 11 has the connector 13, and the detachable module 12 has the corresponding connector 14. For example, when the connector 13 of the external optical disk drive 11 is an integrated drive electronics (IDE) connector, the corresponding connector 14 is also an IDE connector. The external optical disk drive 11 can be the same as the conventional external optical disk drive 1 and is capable of reproducing optical disks or performing music/movie playback. In this embodiment, the detachable module 12 can include an audio output connector 121 and a video output connector 122. In addition, the detachable module 12 can be connected with an audio output device 15 or a video output device 16 via the audio output connector 121 or the video output connector 122, respectively.

Furthermore, when the user would like to attach the external optical disk drive 11 to the detachable module 12, the user connects the connector 13 (IDE connector) of the external optical disk drive 11 to the corresponding connector 14 (IDE connector) of the detachable module 12. The user can place an optical disk (not shown) into the external optical disk drive 11. When the detachable module 12 is attached to the audio output device 15 or the video output device 16, the user can easily enjoy music or movie playback with the optical disk reproducing device 20. Thus, all the user has to do is simply attach the external optical disk drive 11 to the detachable module 12 for the data to be sent to the audio output device 15 or video output device 16. Connection of the external optical disk drive 11 to the host computer 2 is not required.

According to still another embodiment of the present invention, the optical disk reproducing device 20 in accordance with the present invention includes the external optical disk drive 11 and the detachable module 12. The external optical disk drive 11 has the connector 13, and the detachable module 12 has the corresponding connector 14. For example, when the connector 13 of the external optical disk drive 11 is a pin-to-pin male connector, the corresponding connector 14 is a pin-to-pin female connector able to receive the male connector. The external optical disk drive 11 can be the same as the conventional external optical disk drive 1 and is capable of reproducing optical disks or performing music/movie playback. In this embodiment, the detachable module 12 can include an audio output connector 121 and a video output connector 122. In addition, the detachable module 12 can be connected with an audio output device 15 or a video output device 16 via the audio output connector 121 or the video output connector 122, respectively.

Furthermore, when the user would like to attach the external optical disk drive 11 to the detachable module 12, the user connects the connector 13 (pin-to-pin male connector) of the external optical disk drive 11 to the corresponding connector 14 (pin-to-pin female connector) of the detachable module 12. The user can place an optical disk (not shown) in the external optical disk drive 11. When the detachable module 12 is attached to the audio output device 15 or the video output device 16, the user can easily enjoy music or movie playback with the optical disk reproducing device 20. Thus, all the user has to do is simply attach the external optical disk drive 11 to the detachable module 12 for the data to be sent to the audio output device 15 or video output device 16. Connection of the external optical disk drive 11 to the host computer 2 is not required.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. An optical disk reproducing device, comprising:
an external optical disk drive, including a first connector;
a detachable module, including a second connector corresponding to the first connector, and including an audio output connector and a video output connector; and
wherein the external optical disk drive is attached to the detachable module by snapping the first connector into the second connector.

2. The optical disk reproducing device as claimed in claim 1, wherein the detachable module is connected with an audio output device or a video output device via the audio output connector or the video output connector respectively.

3. The optical disk reproducing device as claimed in claim 1, wherein the first connector of the external optical disk drive can be a USB connector, and the second connector of the detachable module can be a USB socket.

4. The optical disk reproducing device as claimed in claim 1, wherein the first connector of the external optical disk drive can be an IDE connector, and the second connector of the detachable module can be an IDE connector.

5. The optical disk reproducing device as claimed in claim 1, wherein the first connector of the external optical disk drive can be a pin-to-pin male connector, and the second connector of the detachable module can be a pin-to-pin female connector.

6. An optical disk reproducing device, comprising:
an external optical disk drive, including a first connector;
a detachable module, including a second connector corresponding to the first connector, an audio output connector and a video connector; and
wherein the external optical disk drive is attached to the detachable module by snapping the first connector into the second connector, and the data from the external optical disk drive is sent to the audio output connector or the video output connector.

7. The optical disk reproducing device as claim 6, detachable module can be connected with an audio output device or a video output device via the audio output connector or the video output connector respectively.

8. The optical disk reproducing device as claim 6, wherein the first connector of the external optical disk drive can be a USB connector, and the second connector of the detachable module can be a USB socket.

9. The optical disk reproducing device as claimed in claim 6, wherein the first connector of the external optical disk drive can be an IDE connector, and the second connector of the detachable module can be an IDE connector.

10. The optical disk reproducing device as claimed in claim 6, wherein the first connector of the external optical disk drive can be a pin-to-pin male connector, and the second connector of the detachable module can be a pin-to-pin female connector.
